(19) United States
(12) Patent Application Publication
(10) Pub. No.: US 2002/0144658 A1
(43) Pub. Date: Oct. 10, 2002

(54) Solids discharge device

(76) Inventors: Dan R. Holcombe, Oregon City, OR (US); Clive Aurthor Edwards, Worthington, OH (US)

Correspondence Address: Dan R. Holcombe, PO Box 1598, Oregon City, OR, 97045, US

(21) Appl. No.: 09/829,805

(22) Filed: Apr. 10, 2001

(51) Int. Cl. A01K 29/00

(52) U.S. Cl. 119/6.7

(57) ABSTRACT

A composting plant e.g. for use in vermiculture, comprises a cruciform type breaker bar unit 16 (FIG. 4) for moving the bottom layer of worm worked material through the perforated floor (elevated Discharge Floor) of the plant.

Alternative designs of breaker bar unit are also described.

The present invention relates to a solids discharge device and in particular, but not exclusively, to one for discharging friable and/or particulate organic material from a container e.g. as part of a vermicomposting system for commercial scale vermiculture.

While the aim of vermicomposing is the improvement of waste material into a useful or marketable product, the production of worms is another aspect of the process as these have a high protein content and when separated from the processed waste, can be used as a feed additive, e.g. for fish farming, or pigs or poultry or dried and added to any animal or livestock feed.

We have tested two production systems, the simplest is a single batch system, where a quantity of waste is inoculated with worms and left until the waste has been broken down, with little success. The much more successful system, is a cumulative-batch layer-feed system. Here a smaller quantity of waste is inoculated with worms and as it becomes broken down another and successive layers are added until the device or vessel reaches harvest level Then processed material is harvested from the bottom through the elevated discharge floor while more waste is added to the top layers, and processed material is harvested. Hence a continuous flow of material in and out of the device is achieved. In both systems, processed waste and worms are harvested in one operation when the whole is removed and another batch is then added. (worms maybe harvested from the top layers of each batch.)

Machines are already known which use one or more augers for discharging compost from a bin, but such arrangements are expensive for large-area bins and also less than satisfactory in a vermicomposting system, for example, where, ideally, processed material should be extracted from the lowermost layers of the charge with only negligible disturbance of the upper worm-containing layers of material.

On-farm and commercial (non-worm) composting systems have been considered, and here the possibilities include the use of expensive screw-auger discharge vessels, or windrow or staticpile composting. The latter option tends to give an inconsistent product and the use of expensive equipment and the expense involved in the former makes it inappropriate.

In addition, problems are often experienced in obtaining a slow, even feed of other difficult solids in soil processing lines, etc. Commonly used equipment comprises a hopper with vertical or near vertical sides astride a very heavy duty belt conveyor of the roller bed type, with massive drive and idler drums powered by a very high torque variable speed drive. Flow rate is determined by a combination of belt speed and restriction of the hopper front aperture. Flow of material through the aperture requires massive shearing forces to be generated.

An object of the present invention is to provide a discharge device by which the disadvantages outlined prior for existing systems may be avoided or at least significantly reduced.

Another object of the patent invention is to provide a continuous or flow through vermicomposting system rather than the batch system referred to prior.

According to the present invention, a discharge device e.g. for friable and/or particulate material, comprises a vessel having an apertured floor, one or more material displacing members engaging with or lying adjacent to the upper surface of the floor, and a drive means for moving the one or more members across the floor, thereby to urge material in the vessel downwardly through the apertures in the elevated discharge floor.

Conveniently, the vessel is square or rectangular when viewed in the plan, the one or more material displacing members comprising an elongated member lying parallel to the length or width dimension of the vessel, and the dive means is operative to move the elongated member in directions parallel to the other of these two dimensions.

Conveniently, the elongated member spans or substantially spans the vessel.

Conveniently, the elongated member has a rectangular or domed cross section.

Conveniently, the elongated member inclines upwardly at each end.

Conveniently, the elongated member has one or more vertical tines.

Conveniently, each tine comprises a flat e.g. triangular, vertical projection having its main plain aligned with the direction of movement of the elongated member through the vessel.

Conveniently, each tine is apertured and the device includes aerating means for supplying air to these apertures.

Conveniently, the aerating means comprises an air supply tube through which air from a pump is provided to the tines e.g. via an air supply reel.

Conveniently, the elongated member referred to prior comprises a first such member, and the one or more material displacing members includes a second elongated member arranged at right angles to the first member.

Conveniently, the first and second material displacing members are arranged so as to be in plan view to provide a simple cruciform structure, preferably unbraced.

Conveniently, the overall length of the second elongated member is not less than about two thirds the overall length of the first member.

Conveniently, the second elongated member inclines upwardly at each end.

Conveniently, the dive means comprises a winch or chain and sprocket system e.g. with the chain or cable, as the case maybe, attached to either end of the second elongated member. (when present) Alternatively, the drive means may comprise one or more hydraulic or pneumatic activators.

The invention also includes a vermicomposting system incorporating a device according to the present invention and in particular, but not exclusively, a continuous flow or flow through vermicomposting apparatus comprising a vessel for a charge of worm-containing waste material, feed means for adding further amounts of said material to the top of the charge, and discharge means according to the present invention, for removing from the bottom of the charge quantities of the material processed by the worms in the container. (continuous or flow through verimcomposting system).

Conveniently, the floor of the container is apertured and the discharge means operates by forcing worm processed material through the apertures in the container floor. (elevated discharge floor).

Conveniently, in this case the discharge means comprises an elongated member adapted to transverse the upper surface of the container floor laterally.

Alternatively, the floor of the container may comprise a plurality of longitudinally finned or otherwise shaped elements of noncircular design, cooperating to provide a floor to the vessel and rotatable about their longitudinal axes to encourage material from the vessel to pass through the elevated discharge vessel floor

Conveniently, in this case, the elements are spaced apart to provide the vessel with an apertured floor and rotation of the elements about their axes, which encourages material to pass through the apertures in the elevated vessel floor.

Conveniently the apparatus includes drive means operative to rotate the elements in a to and fro motion.

Conveniently, the apparatus includes fan means operative to provide a flow of aerating and/or heating air to the undersurface of the charge.

Conveniently. the apparatus includes means for supplying supplementary heating to the middle and/or upper layers of the charge.

Conveniently, the apparatus includes feed means operative to break up lumps in a supply of unprocessed material before loading it onto the upper surface of the charge.

Conveniently, the apparatus includes enclosure means operative to prevent overwetting of the charge by rain when the apparatus is installed in the open air, and to discourage the excessive evaporation of water from the charge in dry conditions.

It is to be noted that the term “apertured” as used prior, and in the claims is to be broadly interpreted as describing any noncontinuous floor for the container, i.e. any floor not wholly closing off the bottom end of the container.

The invention further includes a bedding system for animals, or a feed hopper, when incorporating a discharge device according to the present invention.

According to another aspect of the present invention, a continuous vermicomposting apparatus comprised of worm containing waste material, feed means for adding further amounts of said material to the top of the charge, and discharge means according to the present invention, for removing from the bottom of the charge quantities of the material processed by the worms in the container.

Embodiments of the invention will now be described, by way of example only, with reference to the schematic drawings in which:

FIGS. 1, 2 and 3 are perspective views of different designs of apertured floor for use in a continuous or flow through vermicomposting system;

FIG. 4 is a perspective view of a cruciform unit for displacing material through the apertured floors of FIGS. 1 through 3;

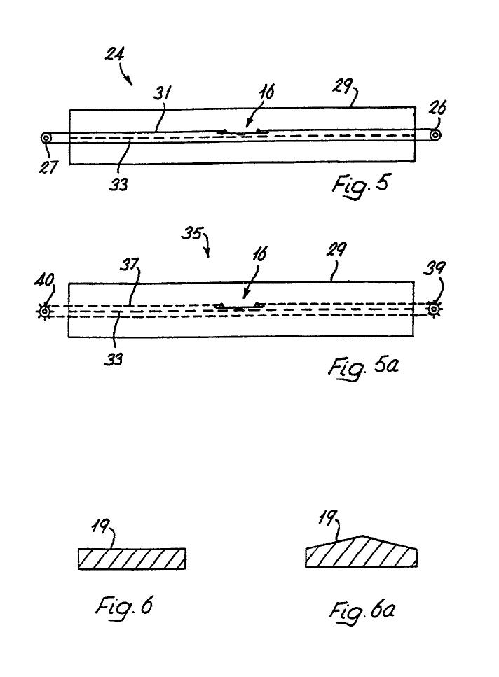

FIGS. 5 and 5a show alternative drives for moving the unit of FIG. 4 from end to end of a container;

FIG. 6 is a vertical section of one or other of the material displacing members used in the unit of FIG. 4, and 6a shows a similar section of an alternative design.

FIG. 7 shows an alternative design of soil displacing unit to that shown in FIG. 4;

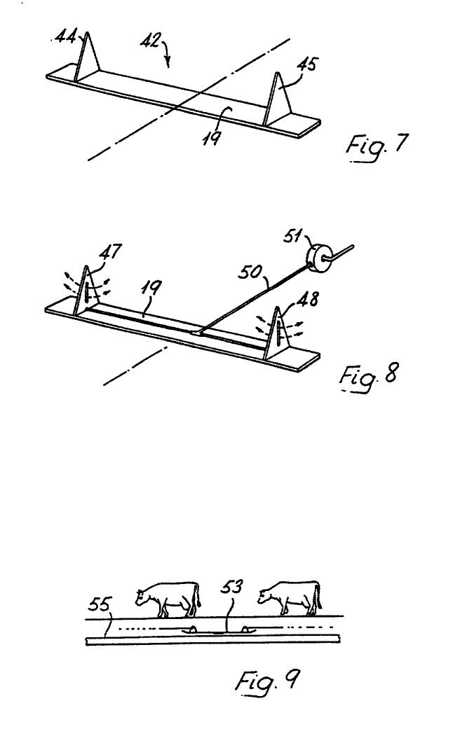

FIG. 8 shows a modification of the design of FIG. 7;

FIG. 9 illustrates how the invention may be applied to a bedding system for animals;

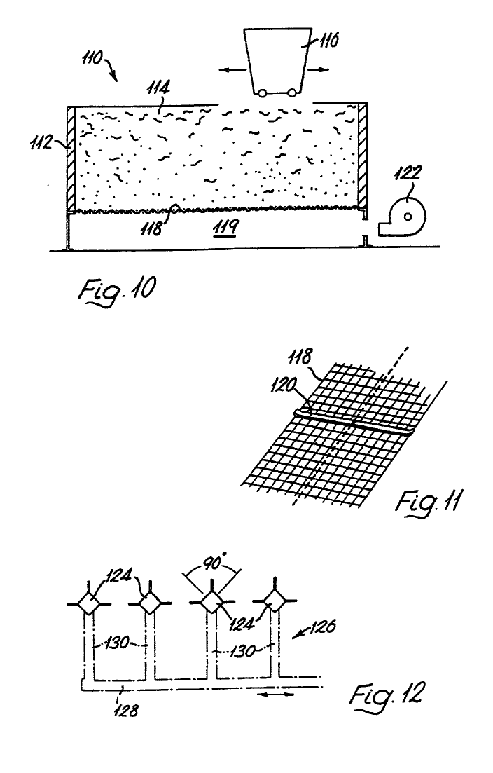

FIG. 10 shows a schematic vertical section through a first embodiment of the apparatus in accordance with the present invention;

FIG. 11 shows a schematic perspective view of a first discharge device for use in the apparatus of FIG. 10;

FIG. 12 is a vertical section of part of an alternative discharge device to that shown in FIG. 11;

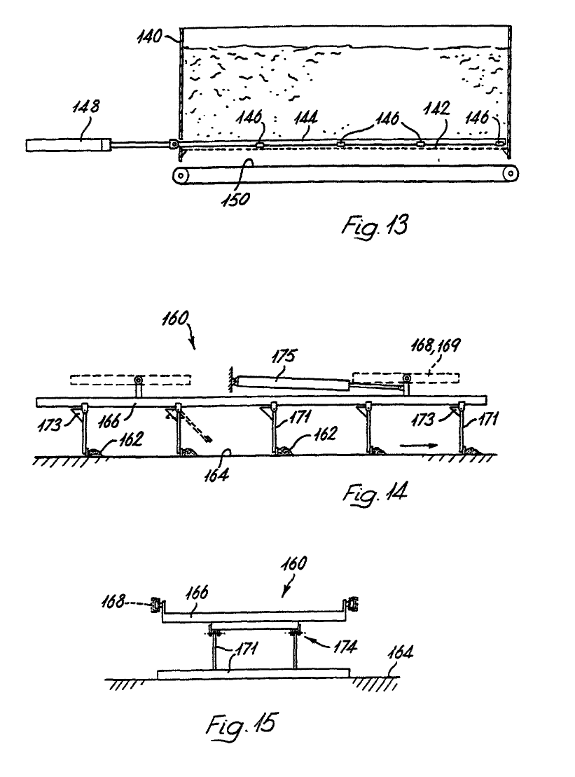

FIG. 13 is a schematic side view of a feed hopper for use with materials that display severe bridging;

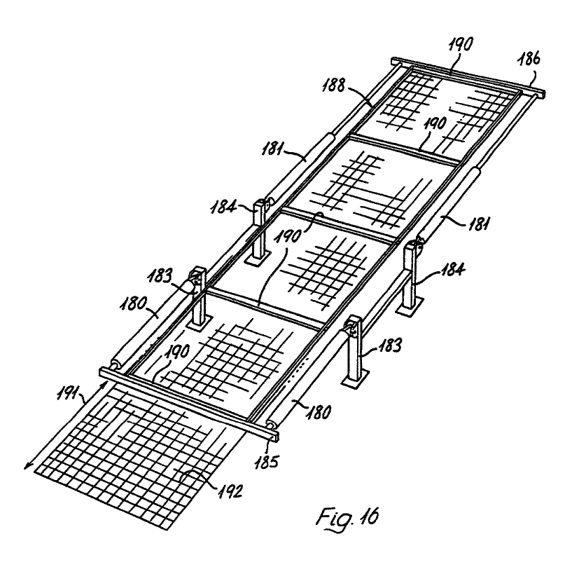

FIGS. 14 and 15 are respectively side and end views of an underfloor collection scraper for use with the apparatus of the previous Figures.

FIG. 16 is a schematic prespective of a dive system for use in some embodiments of the invention.

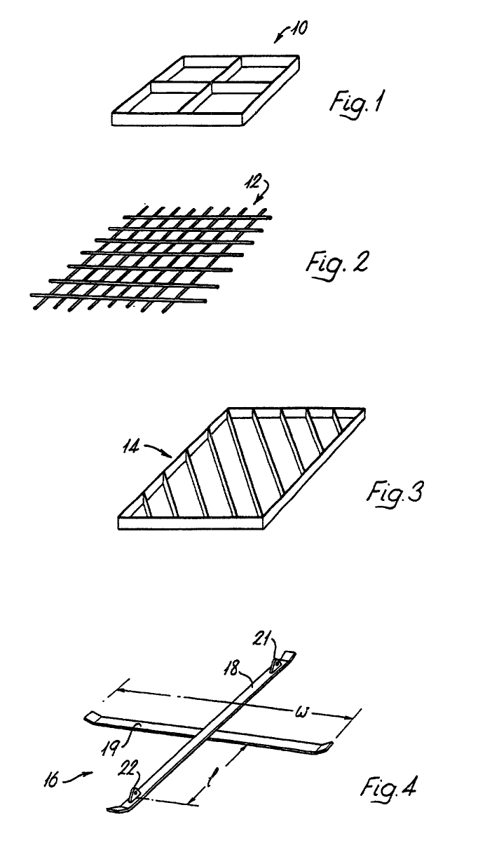

Thus referring first to FIGS. 1 through 3, these show three alternative designs of apertured floor for the container of a continuous or flow through vermicomposting system, namely a grid 10 (FIG. 1) a mesh 12 (FIG. 2), and a slanting bar construction 14 (FIG. 3). In all these designs, the spacing between adjacent floor members (measured perpendicularly to these members) would typically be of a value of from 3 inches up to 7 & 7/18 inches U.S Standard Measure (25 mm up to 75 mm), say.

FIG. 4 shows a simple form of breaker bar unit 16 comprising two elongated members 18, 19 arranged in a simple unbraced cruciform construction.

Lugs 21, 22 extending upwardly from member 18 allow the construction to be pulled in a direction parallel to this member across the elevated discharge floor of the vessel.

The cross-member 19 is dimensioned so as to span or substantialy span the vessel and the length of member 18 is preferably not less than about two thirds of the length of member 19.

In the illustrated embodyment, in fact, the separation L of each lug 21, 22 from the adjacent edge of cross-member 19 was designed to be not more than one third the length W of the member 18.

In the illustrated drawing, both members 18, 19 incline upwardly at either end e.g., at about thirty degrees to the horizontal.

Turning now to FIGS. 5 and 5a, these show alternative designs of drive for use in a layer composting system of, say, to approximately 150 to 225 square feet and 60 to 90 feet in length (50 to 75 square meters corresponding respectively to vessels of 20 meters to 30 meters in length, say). In significantly smaller systems e.g. vessels of 12 to 36 square feet area (4 to 9 square meters), a simple hydraulic ram or smaller linear activator may be employed e.g. as shown in the arrangement of FIG. 3 to be described hereinafter. A modified ram or linear activator system may be used to drive intermediate size soil displacement units, such as shown, for example, in FIGS. 8 to 10 still to be described in detail below. One example of this latter type of drive system will be hereinafter described with reference to FIG. 18.

Referring now to FIG. 5, the drive system 24 comprises, in essence, a winch 26 and idler pulley 27, one at either end of the vessel 29. A steel cable 31 attached to lug 21 passes around the winch 26 and then underneath the vessel floor 33 and back around the idler pulley 27 for attachment to the second lug 22. In the drive system 35 of FIG. 5a the steel cable 31 is replaced by a chain 37 and the winch 26 and idler pulley 27 are replaced by a sprocket drive 39, 40. In alternative systems (not shown), both rotary supports can be driven.

A force of approximately 3,000-4,000N per yard width W of the cross-member 19 will be required to draw the soil displacement unit horizontally across the perforated floor of the vessel, and discharge material therethrough without becoming obstructed by any small stones etc. present in the soil.

Waste rests on the perforated floor of the vessel because of its characteristic tendency to bridge, and the size of the perforations is chosen as the minimum required to ensure the support of the material. On the loading, inevitably some material will pass through. This can be avoided by placing a single layer of waste newspaper over the perforations.

In operation, when drawn over the elevated discharge floor of the vessel beneath the waste layers in a continuous or flow through vermicomposting system, the breaker-bar unit will set up shearing of waste along a line forward of its self. The waste lying below this line is disturbed and its movement results in a localized breakdown of the bridging by which it is supported on the elevated discharge floor of the vessel, hence the terminology “Breaker” bar. Waste above the line of shear remains substantially undisturbed so that worm activity is unaffected. However, there is “Heaving” effect as the bar passes through and this causes some fissuring of settled waste which is beneficial for maintaining aerobicity of the waste. Vertical leading edges of the bar are essential but the bar may be first topped (FIG. 5) or crowned (FIG. 6a) to give more heaving. Because the bar operates in both directions it must always be of uniform cross section.

Turning now to the case of a (non-worm) composting vessel, this would have to be deeper than those used in vermicomposting to achieve the higher composting temperatures required, and certain modifications to the discharge equipment so far described would be desirable. FIG. 7 shows a breaker bar 42 particularly suited for this different environment insofar as vertical triangular tines 44, 45 are now provided to entertain aeration into the waste material. In a variation, hollow tines 47, 48 with internal air feed are used to give localized forced aeration on every breaker bar pass as shown in FIG. 8 where reference numerals 50,51 respectively indicate a tube and air supply reel for supplying air to the tines.

FIG. 9 illustrates another possible use for the equipment. Increasing pressure exists to return to the bedding of animals on straw. However accumulating layers of bedding make the use of fixed height feeders and waterers impossible. In the arrangement of FIG. 9, however, a breaker bar 53 of massive construction running on a large grid elevated discharge floor 55 e.g. 8 inch by 8 inch (200×200 mm), could break out the lower layers of farmyard manure and bedding leaving stock on a pleasant insulating and well drained layer of manure and bedding.

General advantages associated with the illustrated embodiments of the present invention are: low cost, particularly on long containers; true horizontal layer discharge; the mechanically broken discharged layer is suited for easy subsequent handling or mixing; some “Heaving” of the waste can take place to provide air entrainment, but without stirring up the worm active layer in the vermiculture applications; and progressive discharge over the vessel elevated discharge floor area occurs resulting in low actuating forces. In addition, the grid mesh or slanting bar design of floor on which the waste is supported has two features which are very important, namely those of allowing air movement into the waste and some draining of any excess water in the waste.

Referring now to FIGS. 10 and 11 of the drawings, a continuous or flow through vermicomposting apparatus 110 according to the present invention comprises a vessel 112 for a charge of worm containing organic farmyard waste 114.

The organic waste is loaded or fed to the top of the vessel in thin layers (typically 2 to 3 inches or 60 to 70 mm) by a gantry mounted manure spreading trolley 116 extending across the full width of the vessel and able to transverse it from one end to the other, The trolley also serves to break up any lumps initially present in the material. In an alternative arrangement (not shown), the vessel 112 is loaded from the discharge floor of a reception vessel e.g. in the form of a traveling hopper, positioned over the top of the vessel.

Reference numeral 118 indicates the floor of the vessel. This is preferably of an open mesh construction as best seen from FIG. 11. Typically, for example, the floor might be provided with a 2 inch or 2 inch square (50 mm or 75 mm) galvanized steel mesh through which processed waste can be discharged by a chain drawn breaker bar 120 (shown only in FIG. 11).

As will be clear from the drawing, the bar 120 extends across the width dimension of the vessel floor and, in operation, winch units (not shown) will move it transversely from end to end of the elevated discharge floor, typically at about 33 feet per minute. (1000 cm) With the mesh sizes quoted prior and up to about 49 inches (1.25 meters) width, say, the breaker bar might typically be formed from flat steel bar of 2 inches be ¼ inches (50 mm×6 mm) cross section. For a vessel with a width of 8 feet (2.5 meter) the corresponding bar cross section might typically be 2 and ¼ inches by ½ inch (40 mm×12 mm) say.

As an alternative to a mesh floor, closely spaced parallel bars maybe used instead if desired

Clearly, the vessel floor 118 must be raised (identified prior as an elevated discharge floor) above supporting floor or ground level to provide a collection space 119 for material forced through the mesh by bar 120. At other times, at least the lower layers of material in the vessel can be aerated, and optionally also dried to some extent, by a fan 122 adapted to provide a flow of cold or hot air beneath the floor 118. This will also be drying out previously discharged material prior to its removal from beneath the vessel.

Supplementary heating is also possible if desired, e.g. by electric cables (not shown) mounted at a mid or upper position in the vessel. Conveniently, these heating cables will be wound around tensioned steel support cables passing from side to side and/or end to end of the vessel.

Conveniently, the apparatus is completed by thermal insulation and an enclosure (not shown) to prevent overwetting when the vessel is installed in the open air. The presence of the enclosure will also discourage excessive evaporation of water from the waste in dry weather though a misting system (not shown) is also preferably provided as a safeguard to water layers of waste 114 should conditions require. In the event of excess water being provided, this can freely drain through the mesh floor of the vessel.

In operation of the apparatus, the vessel 112 is loaded with worm containing waste as described and the temperature, aerobicity and dampness of the material waste is adjusted if required for optimum conditions.

The high population of worms within the vessel (typically 3 to 6 pounds per square foot) will continually refine the waste, breaking it down to a smaller size.

The worms will continually move upward to new layers of waste as the previous layers become exhausted. Discharge of processed waste through the floor of the vessel at substantially similar intervals to those which new waste is added to the top, maintaining a fixed amount of continually renewed waste for processing in the vessel.

Because worms move up to the fresh waste layers, the processed waste will be substantially worm free and can be discharged through the elevated discharge floor as already discussed for recovery by scraper, conveyor, skip or other suitable means.

In running the apparatus, the aim is always to maintain a high population of worms and achieve maximum throughput of waste.

A typical weekly output of vermicompost when the apparatus is running at optimum is 5.6 cubic yards for every square yard of floor space of the apparatus at 80% moisture content.

In cases where the retention time of waste in the vessel is only four or five days, the waste throughput is too fast to enable worm cocoons to hatch and grow in the vessel, and they will be lost in the discharged material. In this case some addition of small worms may be necessary to maintain the desired level of preformance.

Conversely, if the waste is passed through so slowly the apparatus as to give a waste retention time of 45 to 60 days, for example, the same worms will need to be harvested from the top layer of the waste to prevent a continually expanding worm population.

Where wastes are strongly self heating due to microbial degradation, careful control of feed layer depth and retained depth should be practised with the aim of keeping temperature at 65 to 78 degrees F. optimum. In particular, over heating to above 85 degrees F. should be avoided as above this temperature damage to worm population may result. (optimum 20 to 25 degrees C. over 30 degrees C. can damage worm population)

With the discharge system of FIG. 11, movement of the breaker bar 120 across the vessel floor causes localized breakdown of bridging of contained material and discharge results as the bar advances. However, FIG. 12 shows an alternative design of discharge mechanism in which the vessel floor consists of finned metal square section elements 124 spanning the base of the vessel and able to rotate clockwise and counter clockwise (e.g. through 90 degrees) to obtain through floor discharge of the vessel.

Typically, the elements 124 will be steel tubes or rolled hollow sections to which the fins have been welded. The optimum center spacings of elements 124 with depend on the bridging properties of the material to be discharged but a center spacing of around 6 inches (150 mm) would be typical. Although if the elements are of square or other noncircular cross section, the fins may not be necessary for effective discharge to occur, the fins are nevertheless found to result in a more positive discharge and hence the presence is to be prefered. In the illustration embodiment, the fins might project by 1 inch, (25 mm) say, from the upper three corners of the square section elements 124.

Rotation of the sections 124 in a to and fro motion is by an actuator device 126 in which a common linear actuator 130 is linked to the various sections by a series of crank arms. With relatively small vessels or in small portions of a large unit, it will often be able to operate the linear actuator by hand without mechanical assistance.

As well as its uses in vermicomposting systems, apparatus according to the present invention could also find application in the discharge of materials such as municipal sludge or materials presenting severe bridging or other flow problems.

One such apparatus is shown in FIG. 13 and consists of a hopper 140 with vertical sides and a floor 142 constructed of a steel grid or mesh. The optimum dimensions of the hopper are determined by the type of material to be fed.

Above the hopper 140 and in contact with the floor 142 is a framework 144 supporting a number of members 146 which span the width of the hopper. Members 146 comprise breaker bars of any of the designs illustrated in the previous Figures and they serve to cause localized breakdown of the bridging effect by which the material rests on the floor 142 To achieve this end, the members 146 are caused to reciprocate slowly, say, 4 inches a sec. (100 mm/sec) by, for example, a variable speed electric screw type linear actuator 148. This causes a controlled and even discharge over the whole hopper floor area and has the benefical effect of breaking down lumps and structures within the material.

Below the floor 142 is mounted a simple light duty belt conveyor 150 to collect the discharge and transport it to a delivery point. This conveyor is lightly loaded and its speed is not critical as it does not serve as a metering device. Metering is done by the discharge floor 142, and flow rate is adjusted by the rate at which the linear actuator 148 reciprocates the breaker bar members 146.

In an alternative embodiment (not shown), the breaker bars form part of a motor driven chain loop conveyor, but this detracts from the simplicity and serviceability of a simple reciprocating breaker bar framework. In a further alternative, a rotary (e.g. propeller) breaker is driven by a high torque motor in a suitably proportioned cylinderical hopper having a perforated circular discharge floor.

Referring next to FIGS. 14 and 15, these show an underfloor scraper 160 for collecting waste 162 which has been forced through the apertured floor (not shown) of the vessel by the scraper bars to accumulate on collecting surface 164.

In essence, the scraper 160 comprises a frame 166 running in U-channel tracks 168, 169 and supporting a number of pivoted scraper blade assemblies 171, which lift on rearward movement of the frame 166 wherever they contact a pile of waste 162 on surface 164. In the forward movement, however, pivoting of the blade assemblies is prevented by contact between the lower surface of the frame 166 and abutment plates 173 mounted on the scrapers. The structure of the hinges (174) is such that they will be unaffected by falling waste (see, e.g. FIG. 15).

A double acting hydraulic ram 175 with auto shuttle valve, acts on one of the cross members of the frame 166 to drive the frame in a reciprocatory motion under the vessel floor. During every forward stroke of this motion, the scraper assemblies are held against rotation by the action of plates 173 and act to deliver waste in the direction shown by the arrow in FIG. 14. During the reverse stroke, the blades are free to pivot and ride over the accumulated waste as shown in the dotted line position on the left of this Figure.

Referring lastly to FIG. 16, this illustrates a breaker drive system comprising two pairs of double acting rams 180, 181 arranged in opposition between ground anchors 183, 184 and transverse cross bars 185, 186 of the breaker frame 188 so as to maintain the latter in tension at all times. It will be appreciated that the leading rams are extending with full piston force.

The drive system of FIG. 16 is intended principally as an alternative to the winched arrangements of the earlier Figures for vessels up to 40 feet (10 meters) in length, say, beyond which the power requirements may become excessive. Typically, the breaker bars 190 are flat steel bars, are 8 feet long and 1 and ½ inches wide×½ inch cross section. (2.5 meters long and 40 mm×12 mm cross section) A typical ram stroke 191 and breaker bar center to center distance would be 8 feet (2.5 meters) and the steel mesh floor 192 of the vessel would typically have an aperture size of 3 inches×3 inches, (75×75 mm) say.

Advantages of the drive system of FIGS. 16 are its simple lay out and the absence of winches and cables in a corrosive waste environment.

1.) A discharge device comprising a vessel having an apertured floor, one or more material displacing members engaging with or lying adjecent to the upper surface of the elevated discharge floor, and drive means for moving the one or more members bodily across the floor thereby to urge material in the vessel downwardly through the apertures in the floor.

2.) A device as claimed in claim 1 in which the vessel is square or rectangular when viewed in plan, and the one or more material displacing members comprise an elongated member lying parallel to the length of width dimensions of the vessel, the drive means being operative to move the elongated member in directions parallel to the other of these two dimensions.

3.) A device as claimed in claim 2 in which the elongated member spans or substantially spans the vessel.

4.) A device as claimed in claim 2 or claim 3 in which the elongated member has a rectangular or domed cross section.

5.) A device as claimed in claims 2 through 4 in which the elongated member inclines upwardly at each end.

6.) A device as claimed in any of claims 2 through 5 in which the material displacing member includes one or more vertical tines.

7.) A device as claimed in claim 6 in which the material displacing member or each tine comprises a flat vertical projection having its main plain aligned with the direction of movement of the elongated member through the vessel.

8.) A device as claimed in claim 7 in which the projection is triangular.

9.) A device as claimed in claim 7 or claim 8 in which the material displacing member or each tine is apertured and the device includes aerating means for supplying air to these apertures.

10.) A device as claimed in claim 9 in which the aerating means comprises an air supply tube through which air from a pump is provided to the tines.

11.) A device as claimed in claim 10 in which air is provided to the tines via an air supply reel.

12.) A device as claimed in any of the claims 2 through 11 in which said elongated member comprises a first such member, and the one or more material displacing members includes a second elongated member arranged at right angles to the first member.

13.) A device as claimed in claim 12 in which the first and second material displacing members are arranged so as in plan view to provide a simple cruciform structure.

14.) A device as claimed in claim 13 in which the cruciform structure is unbraced.

15.) A device as claimed in claim 13 or claim 14 in which the overall length of the second elongated member is not less than about two thirds the overall length of the first elongated member.

16.) A device as claimed in any of claims 12 through 15 in which the second elongated member inclines upwardly at each end.

17.) A device as claimed in any preceding claim in which the drive means comprises a winch or chain and sprocket system, or one or more rams or other linear activators.

18.) A device as claimed in claim 17 in which the cable or chain, as the case maybe, is attached to either end of the second elongated member (when present).

19.) A discharge device substantially as hereinbefore described with reference to, and/or as illustrated in, FIG. 1 of the accompanying drawings.

20.) A discharge device substantially as hereinbefore described with reference to, and/or as illustrated in, FIG. 2 of the accompanying drawings.

21.) A discharge device substantially as hereinbefore described with reference to, and/or as illustrated in FIG. 3 of the accompanying drawings.

22.) A discharge device substantially as hereinbefore described with reference to, and/or as illustrated in FIG. 4 of the accompanying drawings.

23.) A discharge device substantially as hereinbefore described with reference to, and/or as illustrated in FIG. 5 of the accompanying drawings.

24.) A discharge device substantially as hereinbefore described with reference to, and/or as illustrated in FIG. 5a of the accompanying drawings.

25.) A discharge device substantially as hereinbefore described with reference to, and/or as illustrated in, FIG. 6 of the accompanying drawings.

26.) A discharge device substantially as hereinbefore described with reference to, and/or as illustrated in, FIG. 6a of the accompanying drawings.

27.) A discharge device substantially as hereinbefore described with reference to, and/or as illustrated in FIG. 7 of the accompanying drawings.

28.) A discharge device substantially as hereinbefore described with reference to, and/or as illustrated in FIG. 8 of the accompanying drawings.

29.) A discharge device substantially as herein before described with reference to, and/or illustrated in FIG. 9 of the accompanying drawings.

30.) A vermicomposting system incorporating a discharge device according to any preceding claim.

31.) A continuouus vermicomposting apparatus as claimed in claim 39, comprising a vessel for a charge of worm containing waste material, feed means for adding further amounts of said material to the top of the charge, the discharge device being effective to remove from the bottom of the charge quantities of the material processed by the worms in the vessel.

32.) An apparatus as claimed in claim 31 in which the floor of the vessel is apertured, and the discharge means operates by forcing worm processed material through the apertures in the vessel floor. (elevated discharge floor)

33.) An apparatus as claimed in claim 32, in which the discharge means comprises an elongated member adapted to transverse the upper surface of the vessel floor laterally.

34.) An apparatus as claimed in claim 31, in which the floor of the vessel comprises a plurality of longitudinally finned or otherwise shaped bars of noncircular cross section, cooperating to provide a floor to the vessel and rotatable about their longitudinal axes to encourage material from the vessel to pass through the vessel floor.

35.) An apparatus as claimed in claim 34 in which the elements are spaced apart to provide the vessel with an apertured floor and rotation of the elements about their axes encourages material to pass through the apertures in the vessel floor.

36.) An apparatus as claimed in claim 34 or claim 35, including drive means operative to rotate the bars in a to and fro motion.

37.) An apparatus as claimed in any of the claims 30 through 36, including fan means operative to provide a flow of aerating and/or heating air to the underside of the charge.

38.) An apparatus as claimed in any of the claims 30 through 37, including means for supplying supplementary heating to the middle and/or upper layers of the charge.

39.) An apparatus as claimed in claims 30 through 38, including feed means operative to break up lumps in a supply of unprocessed material before loading it onto the upper surface of the charge.

40.) An apparatus as claimed in any of the claims 30 through 39, including means for watering the upper layers of the charge.

41.) An apparatus as claimed in any of the claims 30 through 40, including enclosure means operative to prevent overwetting of the charge by rain, when the apparatus is installed in the open air and to prevent the excessive evaporation of water from the charge during dry conditions

42.) An apparatus substantially as hereinbefore described in, FIGS. 10 and 11 of the accompanying drawings.

43.) An apparatus substantially as hereinbefore described with reference to, and\or as illustrated in, FIGS. 14 and 15 of the accompanying drawings

44.) An apparatus substantially as herein before described with reference to, as illustrated in, FIG. 13 of the accompanying drawings.

45.) An apparatus substantially as hereinbefore described with reference to, and/or as illustrated in, FIGS. 14 and 15 of the accompanying drawings.

46.) An apparatus substantially as hereinbefore described with reference to, and/or as illustrated in, FIG. 16 of the accompanying drawings.

47.) A bedding system for animals when incorporating a device according to any of the claims 1 through 29.

48.) A feed hopper when incorporating a device to any of the claims 1 through 29.
